(19) United States
(12) Patent Application Publication
(10) Pub. No.: US 2010/0094581 A1
(43) Pub. Date: Apr. 15, 2010

(54) Method for tracking and reporting personal hand hygiene dispenser electronic time-stamp data

(76) Inventor: Ron Cagle, Ventura, CA (US)

Correspondence Address: SANDRA LEE LIPKIN A LAW CORPORATION, P.O.Box 3518, VENTURA, CA, 93006, US

(21) Appl. No.: 12/587,434

(22) Filed: Oct. 6, 2009

Related U.S. Application Data
(60) Provisional application No. 61/195,460, filed on Oct. 6, 2008.

(51) Int. Cl. G01D 1/00; G04F 10/00; G08B 23/00

(52) U.S. Cl. 702/127; 340/573.1; 702/176

(57) ABSTRACT

Systems and methods for hand hygiene compliance management include a hand-held personal liquid dispenser including a pump and pump plunger that dispenses liquid from a reservoir inside the dispenser when depressed. The dispenser includes circuitry that detects and records each depression of the plunger, and a port for connection to an external computer to transfer data such as identifiers for the dispenser and its user, and time and date of dispenser usage. A tracking and reporting system is disclosed that allows for the collection of nationwide data for standards per setting and health care worker and the report of same.

### REFERENCE TO PRIOR APPLICATION

This application claims the priority of provisional application 61/195,460, filed Oct. 6, 2008 entitled METHOD FOR TRACKING AND REPORTING PERSONAL HAND HYGIENE DISPENSER ELECTRONIC TIME-STAMP DATA by Kirk V. Ogrin and Ronald C. Cagle.

### BACKGROUND OF THE INVENTION

1. Field of the Invention

The present invention relates to a method for tracking and reporting personal hand hygiene dispenser electronic time-stamp data that is gathered and utilized in a patent application held by the current applications entitled SYSTEMS AND METHOD FOR HAND HYGIENE COMPLIANCE MANAGEMENT AND HORIZONTAL PUMP DISPENSER THEREFOR under application Ser. No. 11/724,090 and filed on Mar. 13, 2007.

2. Description of the Prior Art

The dispensers of this invention are of a size and shape for personal use, and for delivery onto the palm of a human hand, of fluids such as sanitizers. These dispensers include an internal pump, horizontally or angularly disposed inside the dispenser, and a container for holding fluids to be delivered by the dispenser. The dispenser also includes a slidable cover or cap that includes an indentation that afits over the end of the plunger for the pump. The indentation includes an opening for delivery of fluid from the dispenser. In use, a user pushes against the cap, sliding the cap against, and depressing the plunger of the pump to deliver fluid from the dispenser. In preferred embodiments, the dispenser includes a clip, preferably a detachable clip, on its external surface, for attaching the dispenser to the clothing of a user.

Such dispensers may also include, in preferred embodiments, an internally-positioned data acquisition circuit, e.g., a printed circuit board or a computer chip. The board or chip is linked to the pump plunger so that each time the plunger is depressed, a switch such as a microswitch closes, and the board or chip records the date and time of the event. The board or chip includes a port for connection to an external computer to permit transfer of data, e.g., the user's name or other unique identifier, a dispenser identifier, and usage data, from the internal board or chip to the external computer. Communications with an external computer can also be achieved with infrared, radio or other wireless technologies. Some dispenser embodiments may position the board or chip inside the cover of the dispenser, with the port in the cover as well.

These systems and methods of the instant invention schedule each health care worker (HCW) or other participant for education/training, including periodic electronic tracking, and help to manage who gets dispensers with the tracking circuits, and the downloading of data from the dispenser. Scores are maintained. An audio behavior modification training circuit inside at least some of the dispensers prompts use with an audible reminder cue, e.g., the sound “pssss,” as part of hand hygiene and compliance.

These systems and methods identify HCWs whose hand hygiene electronic tracking data falls outside desired usage standards. For repeated lack of adherence to desired usage standards, training reinforcement may include verbal review, retraining and administrative sanctions. These systems and methods also generate usage reports for managers and auditors. Adherence and noncompliance usage thresholds are defined and compared against HCW usage data. Adherence/non-adherence data is delivered to rewards and/or to a re-training/usage reinforcement program. Thresholds, rewards, and remedial measures may be defined. Audits are simplified with the documentation these methods and systems provide.

These systems and methods may include record keeping and scheduling, e.g., scheduling of committee meetings, documenting processes, and managing information dissemination. The system maintains an inventory of dispensers and a database of locations/venues. The scheduler generates instructions and lists for promotional material distribution.

Compliance management systems and methods synthesize the key components of an enterprise-wide (e.g., a hospital), comprehensive, multidiscipline, multimodal hygiene program as called for by CDC October 2002 hand hygiene guidelines. Every HCW is tracked through education, training and ongoing spot checks. Training may include computer training, in-service classroom sessions, and hands-on sessions. These systems and methods simplify scheduling and coordination of dispenser usage and education/training.

A circuit is built into each personal dispenser. Every time a dispenser is used, a microswitch is closed and a microcontroller logs usage date and time data. Each dispenser is checked out and assigned to a user running the PC software and plugging in the dispenser. Later, the dispenser is plugged back in as prompted by the software and the data from the dispenser is downloaded into an MS-Access database. Using MS-Access, reports may be generated to view and extract data, and to prepare more detailed or summary reports for export other use.

Personal dispensers for use in these systems and methods have a tracking circuit that can pass personal usage compliance data into an external computer. The data is used for feedback during a training, for ongoing performance evaluation, and for periodic reviews. The electronic tracking system provides a real-time usage data collection and reporting system. The system provides tracking of multiple personal, single-hand, body-worn hand sanitizer dispensers and includes a system to report on usage by user, time, date and other parameters. Systems can include a cable; a printer, and a data CD burner. Reports may include a header record, dispenser records, and time/date records generated each time a dispenser is used.

An audio trainer circuit is built into the dispenser. The circuit provides an audio reminder or cue for users to prompt desired regular dispenser use. A user undergoes a training period, e.g., 1 to 14 days, to make the use of the personal dispenser a habit. Most users temporarily use the audio training circuit to prompt them to the new behavior (“pssss” sound). The personal dispenser then becomes the user's primary hand sanitation device when hands are not visibly soiled.

Radio frequency (RF) or infrared (IR) technology may be used to transfer usage or hand hygiene opportunity data (time stamp sequential records) from either a personal, single-hand, body-worn hand sanitizer dispenser or another unit to a computer. For example, such a computer and an RF or IR receiver may be placed in a frequented area of a facility, e.g., main entrance, employee entrance, or cafeteria. When a personal dispenser with a trainer circuit enters such an area, the data transfer is initiated, successful transfer verified, and the trainer circuit is reset for further data collection. The trainer circuit may be aboard a dispenser or connected, by hard wires or wirelessly, to another unit to be carried by an HCW. Before a dispenser is placed into service, it is initialized by the computer, including the assignment of a unit ID, to a user. Any downloaded data is then associated with the appropriate user's record. Reports from the computer can be generated to lists and to notify any users who have failed to download their dispenser data. The dispensers can also be located on a wall mount which can also communicate with the dispensers using wireless technologies, such as infrared and radio frequencies.

There is also a need to detect electronically when HCWs enter and/or exit patient care zones so that an audible reminder cue to sanitize hands can be made. The system may also detect when a worker enters a patient zone or other hand hygiene opportunity zone, and then record opportunity time/date data for later collection, and/or may generate an audible or visual cue to sanitize one's hands. Radio or RFID technology may be used. Transceivers, receivers, and transmitters all can be used either on/near the patient or on/near a worker. For example, an active patient RFID tag may be connected to a patient bed or installed near a patient room. An RFID receiver may also be in the sanitizer dispenser or another enclosure carried by an HCW. When an HCW's receiver detects an RFID tag, it may generate an audible/visible cue to sanitize hands and/or record a time/date stamp record for transfer to a computer. A passive RFID tag may also be used.

Another method places an RFID tag on an HCW an a receiver in a patient care zone. Time/date stamp data may be collected using direct wire connection, infrared wireless, or radio wireless technologies.

Examples of detecting an HCW or other worker entering a patient care zone for electronic tracking of hand hygiene opportunities and for generating an audible/visible reminder are: 1) a radio transmitter may be placed on or near a patient and a radio receiver may be carried by an HCW or other worker, 2) a radio receiver may be placed on or near a patient and a radio transmitter may be carried by an HCW or other worker, or 3) a radio transceiver may be placed on/near patient and a radio transceiver may be placed on an HCW. The radio transmitter may be an active or passive RFID tag. The transmitter or receiver may also be a transceiver. All receivers, transmitters, and transceivers may be placed in a personal hand sanitizer dispenser, in a wall mounted hand sanitizer dispenser, or in another enclosure to be clipped or otherwise linked to a person, object, or surface.

In the example of a radio transmitter placed on or near a patient with a radio receiver linked to an HCW, an active RFID tag may be placed on a patient's bed. When an HCW enters a room carrying on RFID receiver, mounted in a personal hand sanitizer dispenser or in another unit, the receiver detects and reads the ID of the tag when the HCW is within range of the tag. The HCW receiver device may optionally emit an audible or visual reminder to the HCW to sanitize. The tag and the time/date are then recorded by a receiver circuit, e.g., a microprocessor with memory. The data stored in the HCW receiver device may be then transferred to a computer via a wire connection or wirelessly.

In an example of a radio receiver placed on or near a patient with a radio transmitter carried by an HCW, an active RFID tag may be placed inside a personal hand hygiene dispenser worn by an HCW. An RFID receiver may be placed on or near a patient's bed. When the HCW comes within range of the patient bed, the RFID receiver reads the HCW's tag and uses its microprocessor to record the ID and the time/date stamp. These records may then be transferred to a computer, e.g., an acquisition computer such as a handheld computer, through a direct connect wire, e.g., a serial connection via a USB converter cable, or wirelessly, e.g., by radio communication.

In the example of a radio transceiver placed on/near a patient and a radio transceiver carried by an HCW, a transceiver may be placed inside an HCW's personal hand sanitizer dispenser or in a separate unit the HCW carries, e.g., on a belt or attached to clothing. A patient or a patient's bed has a transceiver placed near to the patient or the patient's bed, e.g., enclosed in a small button attached to a patient, or in an enclosure attached to the bed. The patient transceiver emits a periodic signal, e.g., every 0.1 seconds. When an HCW enters a patient zone, the HCW's transceiver detects this signal from the patient's transceiver. A signal is then sent from the HCW device to the patient's device to acknowledge receipt of this signal. Both an HCW and a patient device may emit an audio and/or visual reminder for the HCW to sanitize his/her hands, and for the patient to remind the HCW to sanitize his/her hands. The HCW will also know that the patient has been cued, reinforcing the reminder. The HCW unit may then log to the patient device ID and store it as a time/date stamp record for transfer to a computer or other storage device.

A personal sanitizer wireless data transfer allows data collection of hand hygiene compliance and hand hygiene opportunity data with minimal effort from HCWs and their administrators. The capability of detecting an HCW entering a patient care zone provides opportunities to remind the HCW to sanitize, and to collect hand hygiene opportunity data. Combined with the usage data, matching opportunity to compliance provides powerful incentives to compliance.

Dispenser system components include: micro-switch, audio amplifier, timer circuit, logic circuit, volume control (potentiometer or software controlled), on/off switch (switch or software controlled), dip switch (software controlled), and speaker. When a dispenser pump plunger or other actuator is pressed to express the sanitizer the switch is depressed, and the circuit generates an audible cue, e.g., a “pssss” sound. The timer is then reset, and the timer begins to count down. When/if the timer times out before the unit is again used, the circuit generates the “pssss” sound and the process repeats. The dispenser will continue to generate the reminder sound until the dispenser is used or is turned off. If the dispenser is not used after a short time, e.g., 3 minutes, the “pssss” sound is generated. The volume and time interval are programmable, and may be set from a dip switch or set from a computer. A microswitch is in the dispenser. The circuit can be turned off using a switch or by holding down the dispenser cap for a brief period, e.g., 10 seconds. The duration of nonuse time-out (the duration between reminders when not used), can be adjusted under software control when in communications with the central computer or by using dip switch settings on the printed circuit board. The dispenser may include a micro-trigger, printed circuit board, battery, and connector in the cap. Each dispenser has a unique identifier in the circuit, delivers real-time data time/date stamp records, and includes an export port and a battery.

A data acquisition computer stores and exports/data acquisition computer stores and exports time/date stamp records. Such a computer for receiving data from dispensers may include a workstation, performance and storage to current standards; current version of MS-Access or other database system; connection to dispensers via serial or other cable; a printer, and a data CD burner. Reports may include a header record, dispenser records, and time/date records generated each time a dispenser is used and summary reports and graphs by hour, shift, month, year, HCW, or ward unit.

Organizing record-keeping, scheduling, and other contact management type functionality to manage this unique hand hygiene program is new. The use of a personal, body-word hand hygiene dispenser with tracking electronics and an audio cue are also new. The comparison of usage data to preestablished usage data norms to identify nonadherence is also new. Using wireless technology to download adherence data from a personal sanitizer dispenser, and using radio or other technology to identify which workers entering or exiting a patient care zone are new.

The current invention now seeks a method of tracking and reporting the personal hand hygiene dispenser electronic time-stamp data collected in the method described in detail above and what is the subject of the previously filed non-provisional application referenced in the Field of the Invention.

### BRIEF DESCRIPTION OF THE DRAWINGS

This invention can better be understood by reference to the drawings, provided for exemplary purposes, and in which:

FIG. 1 is a side elevation view of an embodiment of a personal, hand-held dispenser with a horizontally-disposed, internal pump.

FIG. 2 is a side elevation view of the dispenser shown in FIG. 1, taken on line B-B of FIG. 1.

FIG. 3 is a top plan view of the dispenser shown in FIGS. 1 and 2.

FIG. 4 is a perspective view of the dispenser shown in FIGS. 1, 2 and 3.

FIG. 5 is a side elevation view, taken in cross-section on line A-A of FIG. 3.

FIG. 6 is an end elevation view of the dispenser of FIGS. 1-5, taken in cross-section on line C-C of FIG. 1

FIG. 7 is a detail view of the dispenser as shown in FIG. 6.

FIG. 8 is an end elevation view of the dispenser of FIGS. 1-7.

FIG. 9 is a side elevation view of the dispenser of FIGS. 1-8.

FIG. 10 is a bottom plan view of the dispenser of FIGS. 1-9.

FIGS. 11A-B are block function diagrams of a memory/computer circuit for use in detecting and recording data, such as the date and time of each use of a device such as the dispenser shown in FIGS. 1-10.

FIGS. 12A-12C are block function diagrams that define the data compiling and reporting function of the instant invention.

FIG. 13 is a first sample printout of the instant invention.

FIG. 14 is a second sample printout of the instant invention.

### DETAILED DESCRIPTION OF A PREFERRED EMBODIMENT

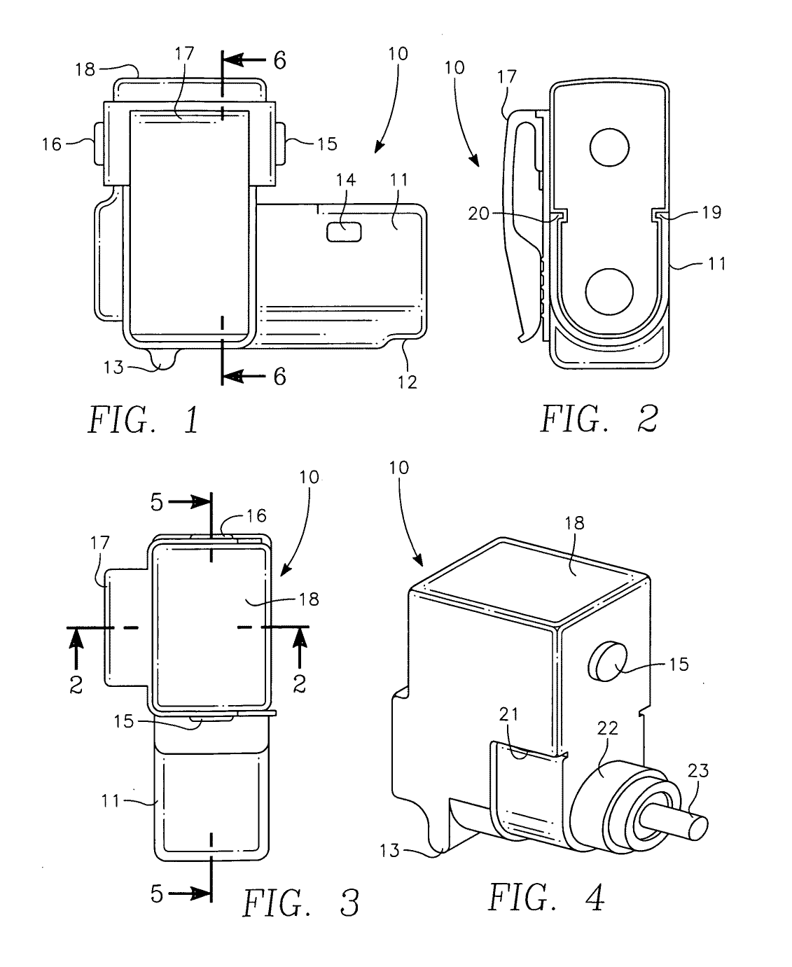

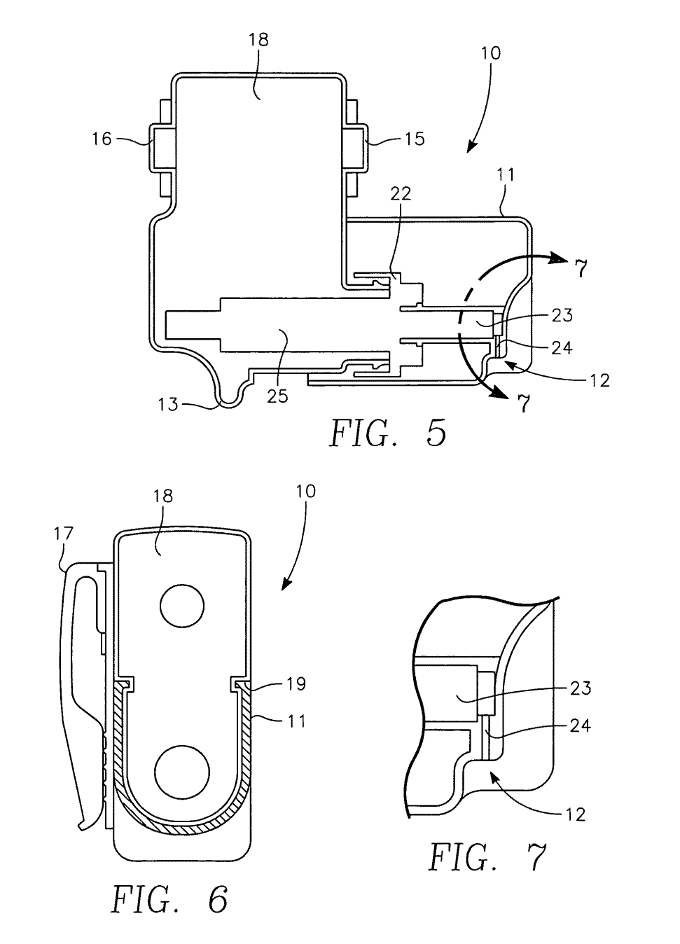

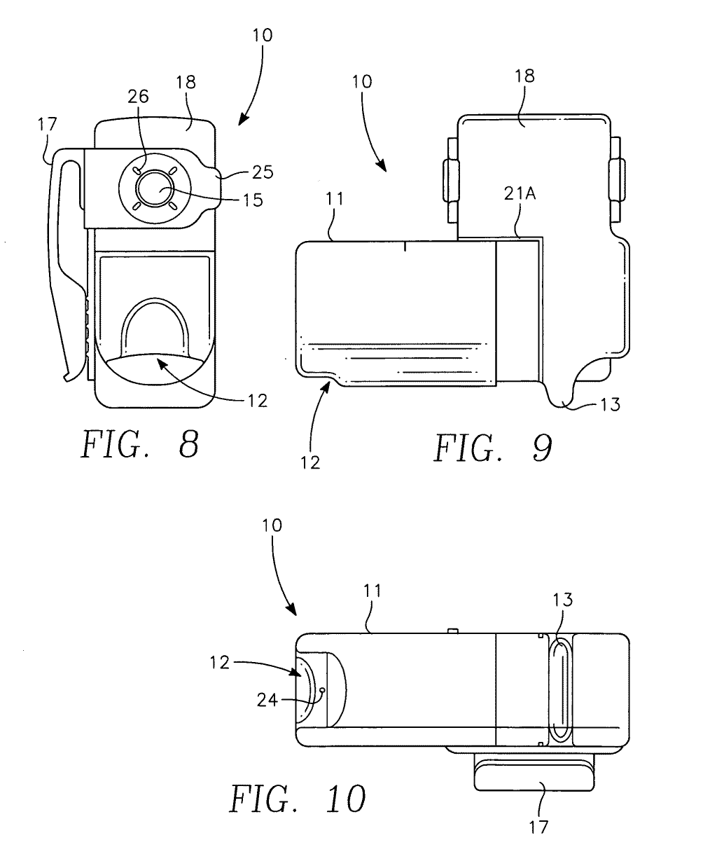

The preferred embodiment of the invention is illustrated in the attached figures. FIGS. 1-10 show a hand-held, personal dispenser 10, including liquid reservoir 18, horizontally-disposed, internal pump 25, external clip 17, external finger hold 13, and liquid exit passage 24. Clip 17 is removable from dispenser 10. Clip 17 is attached to dispenser 10 by bendable flaps 25, which have flexible opening with flex joints 26 to snap fit over annular protrusions 15 and 16 on dispenser 10.

As best seen in FIGS. 2, 4, 6 and 9, cover 11 fits over pump 25, with flanges 19 and 20 on cover 11 fitting slidably into grooves 21 on reservoir 18, and with end recess 12 lying below pump plunger 23 and liquid exit passage 24. In use, dispenser 10 is held in the palm of a human hand, with the index finger curled around finger hold 13, and the end of cover 11 placed against the end of the palm nearest the wrist. Pulling the finger hold 1 toward the palm while pushing the cover 11 toward finger hold 13 depresses plunger 23, drawing liquid from reservoir 18 through pump 25, and then through passage 24 into the palm of the user. Cover 11 slides forward in grooves 21, with flanges 19 and 20 at the upper edges of cover 11, holding cover 11 in place over pump 25.

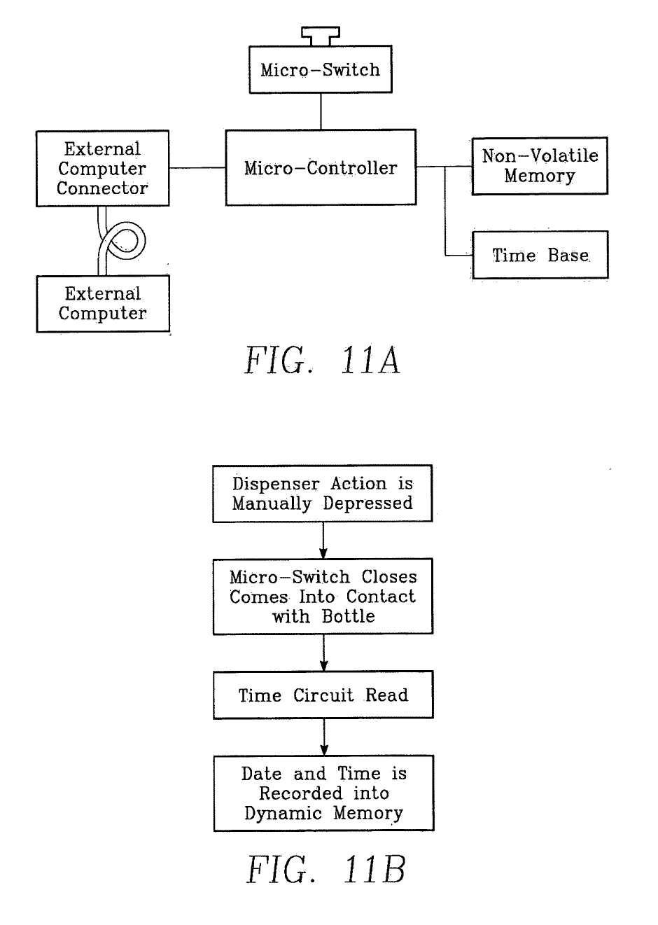

Inside cover 11 is an electrical circuit that includes a tiny switch that closes each time the plunger of pump 25 is depressed. Linked to this switch is a memory and a computer that work together to detect and record the date and time of each such event. A cable is connected to this circuit to pass the recorded information to a computer to track the frequency and time of each person's use of the dispenser for comparison to desired frequency and time of use. This circuit may also emit an audible prompt to remind a user to dispense liquid, such as a sanitizing fluid, at desired times. The computer/memory circuit may be useful in other devices, dispensers and otherwise, to detect and record other switch-controlled events that desirably take place at desired intervals. FIG. 11 is a block function diagram of an embodiment of a circuit of this kind.

Inside each dispenser is an electrical circuit that includes a tiny switch that closes each time the plunger of a dispenser pump is depressed. Linked to this switch is a memory and a computer that work together to detect and record the data and time of each such event. A cable is connected to this circuit to pass the recorded information to a computer to track the frequency and time of each person's use of the dispenser for comparison to desired frequency and time of use. This circuit may also emit an audible prompt to remind a user to dispense liquid, such as a sanitizing fluid, at desired times. The computer/memory circuit may be useful in other devices, dispensers or otherwise, to detect and record other switch-controlled events that desirably take place at desired intervals. FIG. 11 is a block function diagram of an embodiment of a circuit of this kind.

Hand hygiene episode measurement is based on electronic usage data from a personal hand hygiene dispenser. Every time the personal dispenser is used, a time and date stamp is recorded as a hand hygiene episode in a computer chip aboard the dispenser. That data is downloaded into a computer. Provider performance feedback and administrative reports are generated based on that data.

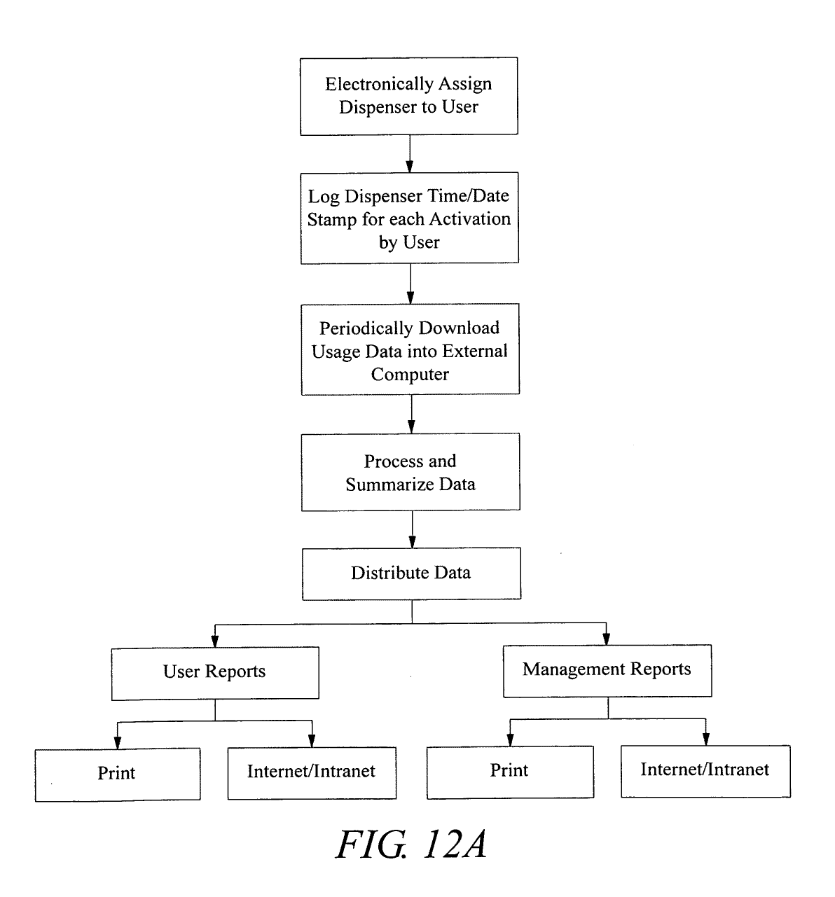

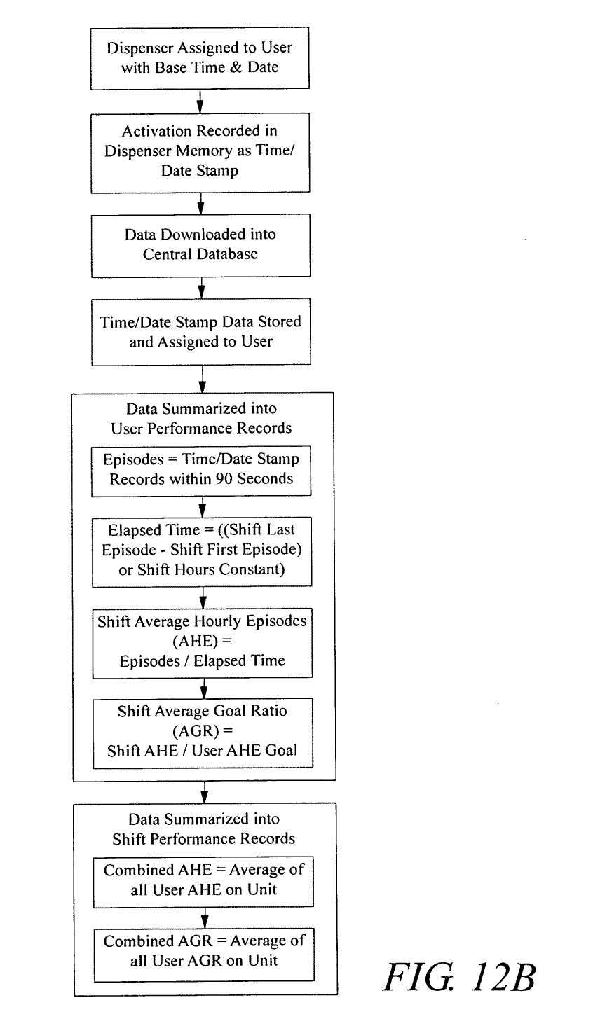

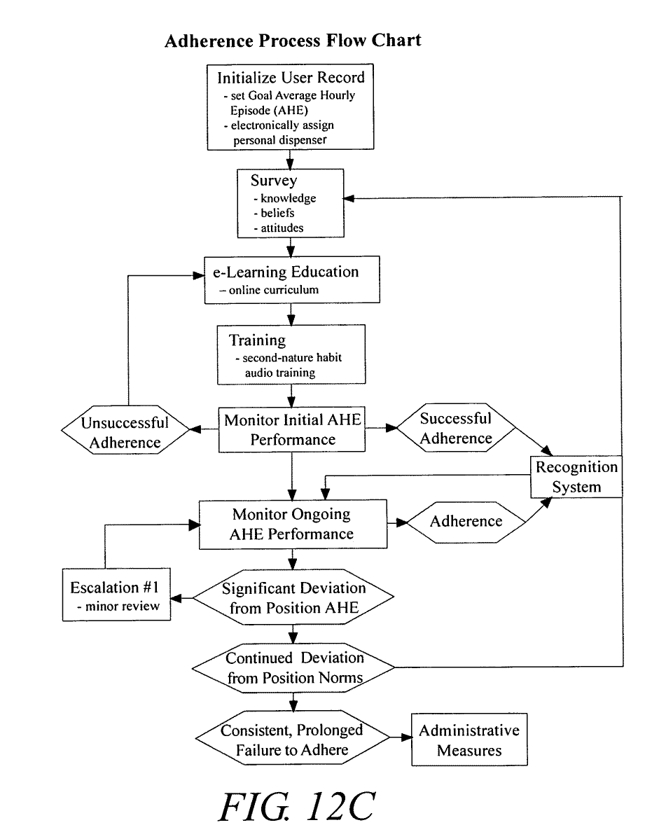

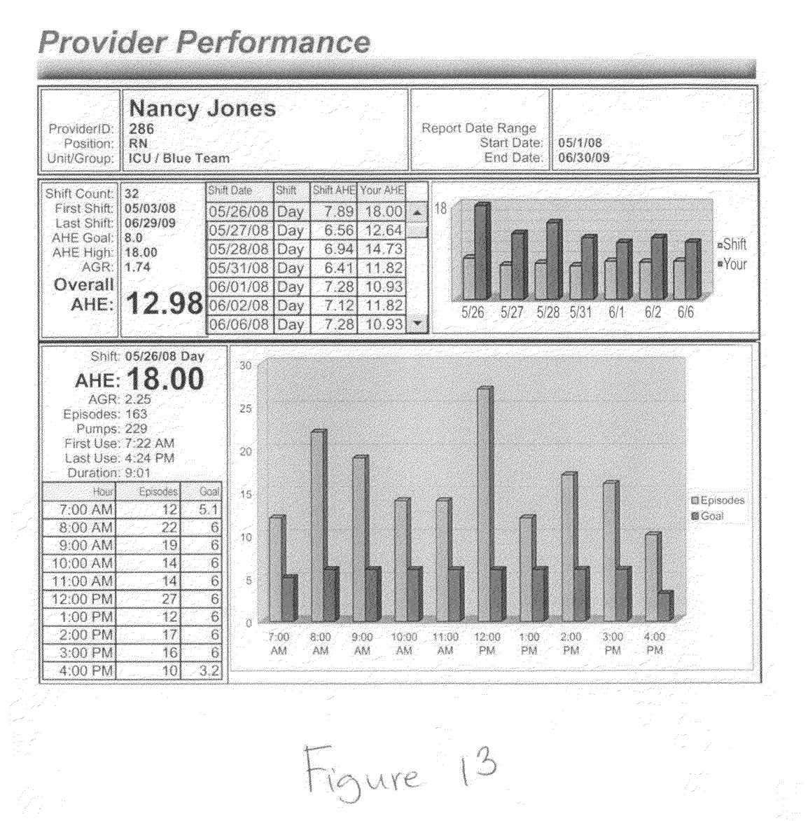

FIG. 12A shows a flow chart of the process of the instant invention. A dispenser is electronically assigned to the user. It is then logged via time/date stamp for each activation by the user. The data is periodically downloaded into and external computer. The computer processes and summarizes the data. The computer then distributes the data into either user reports or management reports. Reports can be generated using paper or electronic formats.

FIG. 12B shows a more detailed flow chart. After the dispenser is assigned to a user with a base time and date, the activation is recorded in the dispenser's memory as a time/date stamp. The data is downloaded into a central database. The time/date stamp data is stored and assigned to the user. The data is then summarized into user performance records and shift performance records, details of which are illustrated in the flow chart.

FIG. 12B shows an adherence process flow chart. A new user's record is initialized by setting the average hourly episode goal and electronically assigned a dispenser. Surveys are taken that illustrate the knowledge, beliefs and attitudes of the user. Once this is done, training as needed can be supplied, either through e-learning online curriculum education or through training, such as second-nature habit audio training. The initial performance is then monitored. If there is unsuccessful adherence, the training step is repeated. Once there is successful adherence, the recognition system then monitors ongoing performance. If there is adherence, this information is sent to the recognition program. If there is a significant deviation from adherence for the position average hourly episodes, a minor review takes place that goes into the ongoing monitoring of performance. If there is continued deviation from norms, the survey step is returned and the sequence repeated. If there is consistent, prolonged failure to adhere, administrative measures are then undertaken.

The feedback from the time/date stamp data is in two basic forms. The first basic form includes episode counts for each working hour. The second basic form includes average hourly episodes (“AHE”) that are calculated for a shift or other time period. The performance goal is to maintain consistent use throughout a shift. Multiple pumps of the dispenser are counted, but summarized into discrete episodes. The time stamp data makes attempts at gaming or fooling the system obvious.

Individual performance feedback data is presented within the context of an individual performance AHE goal for each provider shift. A goal is unique to the position and setting of each provider and is based on a collective national database. It is the role of the collective national database along with clinical studies to establish position and setting performance thresholds. The method provides a means to clinically tie hand hygiene episode thresholds to infection rate improvements.

In order for episode reporting to be meaningful to individual providers, it must be within the proper context of an individual performance goal. Since it is important to define performance goals for providers based on both position and setting, a charge registered nurse, for example, in a small rural medical surgical unit and a licensed nurse's assistant in a 25-bed urban intensive care unit should not be held to the same hand hygiene performance goals.

Usage metrics and goals will evolve as personal dispenser episode data is collected from various settings and positions. Standards emerge as the database grows and is shared. Episode based data makes this process logistically possible as it is based on electronic data that is consistent and easily acquired.

The method's most basic measure of hand hygiene events are termed “Episodes.” There is an electronic trigger inside the personal dispenser that each time it is squeezed beyond 75% of the total travel length of the pumping mechanism (this travel threshold can be adjusted as required), the trigger is activated and a time stamp record is generated and is then stored in the memory of the device for download into a computer.

Each time stamp record is a “Pump” record. Episodes are hand hygiene events summarized from the Pump records. A Pump is counted as an Episode. The exceptions are Pumps generated within 90 seconds of each other, those of which are summarized as a single Episode.

The ratio of Pumps over Episodes reports the average Pumps/Episode. Some providers may need more than one Pump for an appropriate amount of sanitizer. The Pump to Episode ratio represents the average sanitizer dosage per Episode for an individual provider. A ratio approaching 3.0 may be an indication that the provider is using the dispenser outside of its intended purpose.

There are two points of reference in categorizing episode data: episode data per provider and episode data per patient. The primary method of representing episode data for provides is the collection of AHE. AHEs are Episodes/Elapsed Time (Hour). Elapsed time roughly represents shift length, but is not assumed to be the length of the shift. Elapsed time is calculated using the provider's first and last pump records of a shift. Providers often arrive early and almost always stay late after the hand-off. They are also known to work partial or extended shifts that do not follow the usual shift change times. By using the first and last pump records to establish an elapsed time as the denominator for AHE, a more accurate picture of actual provider rate of hand hygiene episodes can be calculated.

AHE can be calculated for the provider or for the patient. Provider AHE is the primary measure as the focus is on helping providers increase and sustain their hand hygiene to achieve reduced infection rates. The formulate for calculating provider AHE is: AHE=Episodes/Approximate Shift Duration where Approximate Shift Duration=Last Shift Time Stamp−First Shift Time Stamp. For Example, where 10.0 AHE=121 Episodes/(7:18 PM-7:23 AM) the Approximate Shift Duration is 12:04. The range of AHEs for a nurse can be from 0.1 to 25.0 or higher. A study in the Dartmouth-Hitchcock Medical Center ICU has a number of RNs who routinely perform from 14.0 to 20.0 AHEs.

Average Daily Episodes (ADEs) represent provider episode data in reference to the provider day. ADE is an appropriate measure for the hand hygiene performance of doctors. Doctors often move on and off a unit as they tend to go back and forth from clinical to non-clinical duties. Averaging episodes on a daily basis provides more meaningful feedback for doctors because it avoids the need to establish start and end times of clinical activity. Averaging the ADE for doctors by the week, month, or quarter can be a helpful form of feedback as it helps lessen the impact of non-clinical periods of hand hygiene inactivity.

The formula for ADE is as follows: ADE=Total Episodes/Shift Days. Where total Episodes=Sum of Episodes from Start Date to End Date and Shift Days=Number of Days Measured. An example would be 112 ADE=(92+141+106+128+46+159)/6 Shift Days.

There are three ways of representing Patient episode data: AHE per Patient Day, Episodes per Patient Day and Episodes per 1000 Patient Days.

AHE per Patient Day is an hourly rate for the patient day. The formula for calculating AHE per Patient Day. AHE per Patient Day=Provider Day AHE/Patient to Provider Ratio where Provider Day AHE=Sum of Shift AHE/Number of Shifts and Patient Provider Ratio=Patients/Providers. An example would be 2.94 AHE per Patient Day=((6.41 day shift AHE+5.29 night shift AHE)/2 shifts))/(2 Patients/1 Provider)*24.

Episodes per Patient Day can be converted to 1000 Patient Days simply by multiplying Episodes per Patient Day by 1000. An example: 70,000 Episodes per 1000 Patient Day=70 Episodes per Patient Day*1000.

Adherence Goal Ratio (AGR) allows AHE to be stated within the context of a goal and can be a more appropriate way to combine the episode data of varied types of clinicians. The formula for calculating AGR is Adherence Goal Ratio=(AHEs/AHE Goal). A combined AR can be calculated by averaging the AGR of different positions together.

### EXAMPLE

| | AHE | Goal | AGR |
|---|---|---|---|
| CNA AHE per Patient Day | 8.5 | 12.0 | 0.7 |
| RN AHE per Patient Day | 12.0 | 8.0 | 1.5 |
| Combined | | | 1.1 |

An AGR below 1.0 indicates the number of episodes per hour as less than the goal while an AGR over 1.0 means the goal was exceeded.

The basic data structure of the method is based on four data tables. 1) UnitMaster: each dispenser has a Unit record with a UnitID that is stored in the dispenser, the last reset date/time is kept. 2) ProviderMaster: each healthcare provider has a provider record and ID, name, position, and unit. 3) Assignments: links Unit records to the Provider records. 4) Usage: the time stamp data records are downloaded from the dispensers that are linked to the providers.

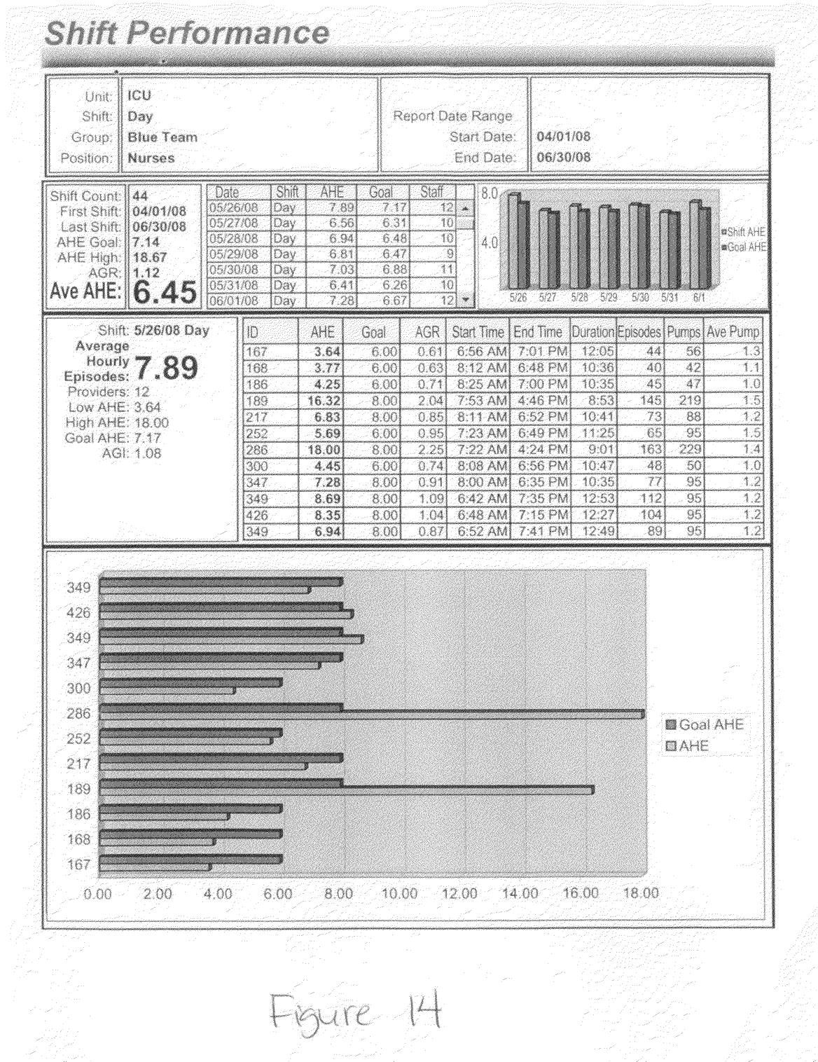

Reports can be expressed as printouts or put into html or other internet compatible output format. FIGS. 13 and 14 provide samples of such reports.

The report is intended to be printed out on 8.5″×11″ paper in landscape. It is an hour-by-hour summary of episodes during a shift. It needs to be generated for an individual provider on a specific shift date, looking up by provider name combination box. Or it could be generated for the last shift of all providers flagged for an upcoming active shift, as flagged in the Active Shift Flag in the ProviderMaster table. The report title is “Provider Hand Hygiene Performance Handout” the group name, the shift date, and the shift name from ShiftName. Time stamp records from the Usage table are summarized into Episodes. There can be multiple pumps per episode. Pumps within on minute are summarized into an episode.

Work Pattern Recognition is a feature (in the software or manual systems) that uses episode data to identify common work patterns. Clinical work most often fits into bursts of recognizable work patterns. Each shift also has its work patterns such as the “handoff” by one clinician (i.e. nurse) to another at the start and end of every shift. Work patterns can coincide with hand hygiene episodes. Episode data can be analyzed to identify these patterns. These patterns can be used to identify periods of low-activity due to non-patient care duties or changes in acuity. They can be used to help identify levels of appropriate hand hygiene within the work pattern or within a work period (i.e. shift). The elapsed time between episodes and then grouping those elapsed times are the essence of the pattern recognition. The patterns can also be used to help clinicians understand better patterns of hand hygiene episodes throughout a common procedure. Work patterns can also help provide more meaningful feedback to clinicians who have sporadic clinical periods; examples are attending or on-call doctors, therapists (occupational, physical, others), and technicians (respiratory therapists, phlebotomists). Other variables such as clinician's position, the clinical setting, patient acuity, record of non-patient care duties, nurse to patient ratio, etc. can be used to help identify and analyze patterns. These other variables can be entered into the system or downloaded/synchronized with other information systems.

It is understood that the wall mount dispensing of solution, or any other method of dispensing, will also be counted in the collection of data for the purpose of establishing standards and adherence thereto. Additionally, the date and time can either be recorded in real time or through use of an offset date or time that is recorded in an external computer.

The illustrations and examples provided herein are for explanatory purposes and are not intended to limit the scope of the appended claims. This disclosure is to be considered an exemplification of the principles of the invention and is not intended to limit the spirit and scope of the invention and/or claims of the embodiment illustrated. Those skilled in the art will make modifications to the invention for particular applications of the invention.

What is claimed is:

1. A system and method for tracking and reporting collected personal hand hygiene dispenser electronic time/stamp data comprising
dispensing to a user a single-hand, body-worn personal solution dispenser for delivery of said solution into the human hand;
electronic tracking of usage of said single-hand body-worn personal solution dispenser;
generating usage data per position and per setting based on episodes wherein an episode is defined as a the activation of the dispenser in order to create standards of compliance that reduce infection rates;
downloading usage data from said dispenser to an external computer; and
reporting reports thereon.

2. The system and method as defined in claim 1 wherein usage data is compiled based on episode counts per working hour, shift, day, week, month, quarter, year or other work period.

3. The system and method as defined in claim 1 wherein dispenser activations that occur within 15 to 120 seconds of each other are recorded as a single episode.

4. The system and method as defined in claim 3 wherein usage data is reported as average activations per episode.

5. The system and method as defined in claim 1 wherein usage data is recorded as episode per provider.

6. The system and method as defined in claim 1 wherein usage data is recorded as episode per patient day, week, month, quarter, year, or other time period.

7. The system and method as defined in claim 5 wherein the measure per provider is number of episodes per hour, work shift, day, week, month, quarter, year or other elapsed time period.

8. The system and method as defined in claim 7 wherein elapsed time is defined as the time of the last activation per work shift less the time of the first activation per shift or the number of working hours in a shift.

9. The system and method as defined in claim 6 wherein the usage data per patient is recorded as the average episode for the provider day or other time period divided by the patient to provider ratio, i.e., the sum of shift average episodes divided by the number of shifts is then divided by the patient to provider ratio.

10. The system and method as defined in claim 1 wherein usage reports are generated that provide the average episodes divided by the average episode goal for each user, the goal to be determined and modified as the collection of said data progresses.

11. The system and method as defined in claim 10 wherein the goal for each user can be modified for each user and/or can be established on a collection of said data based on setting, position and duties.

12. The system and method as defined in claim 1 wherein reports are generated as print-out reports.

13. The system and method as defined in claim 1 wherein reports are generated via html or other Internet compatible output format.

14. The system and method as defined in claim 1 wherein said internally-positioned data acquisition circuit is a printed circuit board.

15. The system and method as defined in claim 1 wherein said internally-positioned data acquisition circuit is a computer chip.

16. The system and method as defined in claim 1 wherein said internally-positioned data acquisition circuit is linked to said dispenser activation.

17. The system and method as defined in claim 1 wherein each time said dispenser is activated, a switch closes and said internally-positioned data acquisition circuit records the date and time of said activation of said dispenser.

18. The system and method as defined in claim 1 wherein said internally-positioned data acquisition circuit further comprises a port for connection to and communication with an external computer to transfer data from said internally-positioned data acquisition circuit.

19. The system and method as defined in claim 18 wherein said data further comprises user identification, dispenser identification and usage data.

20. The system and method as defined in claim 1 wherein said communication with said external communication is accomplished wirelessly using radio frequencies, infrared or other method.

21. The system and method as defined in claim 20 wherein said communication of dispenser data acquisition circuit is in communication with circuits in other hand hygiene sanitizer and soap dispensers.

22. The system and method as defined in claim 21 wherein the internally-positioned data acquisition circuit receives and records another dispenser identification and usage data to track the use of other hand sanitation devices.

23. The system and method as defined in claim 1 wherein the date and time is recorded as real-time data and time or as an off-set of a date and time recorded in an external computer.
